(19) United States
(12) Patent Application Publication
(10) Pub. No.: US 2002/0019601 A1
(43) Pub. Date: Feb. 14, 2002

(54) Health and beauty massage device

(76) Inventor: Masaki Wada, Osaka-shi (JP)

Correspondence Address: FLYNN, THIEL, BOUTELL & TANIS, P.C., 2026 Rambling Road, Kalamazoo, MI, 49008-1699, US

(21) Appl. No.: 09/880,442

(22) Filed: Jun. 13, 2001

(30) Foreign Application Priority Data
Aug. 14, 2000 (JP) 2000-245905

(51) Int. Cl. A61H 15/00

(52) U.S. Cl. 601/131; 601/128

(57) ABSTRACT

A health and beauty massage device whose multiple treatment members make rubbing contact evenly and efficiently which promotes circulation of the blood and burns fat in the areas of the body to be treated. The health and beauty massage device is configured so that multiple treatment members are disposed on a frame body which is provided with a recessed part into which the areas of the human body to be treated are placed or inserted. At the same time, a linking means which links each of the treatment members is disposed between the installation shafts of the adjacent pairs of treatment members. The treatment members are interlocked with at least one drive mechanism and all of the treatment members are rotated at the same time.

### FIELD OF THE INVENTION

The present invention relates to a health and beauty device which sets in place multiple rollers so that they can rotate freely. It relates more specifically to a health and beauty massage device which is configured so that massaging of the arms and other areas of the human body with adipose tissue can be massaged efficiently using multiple rollers, which promotes circulation of the blood in each of these areas and which can burn fat.

### BACKGROUND OF THE INVENTION

There are prior art portable massage devices related to this type of health and beauty device which can be easily carried and which provide efficient massage treatment. These prior art devices are easy to use so that they are valued by the general consumer.

Typical prior art portable massage devices of this type included (1) those in which a large number of rolling members which could rotate freely around cylindrical rotors, the aforementioned massage members providing a rolling type of massage which involved rubbing while making contact with the areas of the human body to be treated; (2) those in which a pair of eccentric members facing each other and centrally disposed so that a rubbing type of massage could be provided to the local areas of the human body by using this pair of facing eccentric members; as well as others. The devices were pleasant to use, they were able to promote circulation of the blood and could relax muscle fatigue and tension, thus providing an efficient massaging effect.

Despite this, the large number of rolling members which were installed around the cylindrical rotors in the prior art portable massage devices mentioned previously made point contact with the areas of the body to be treated by the user and carried out a rolling type of massage. As a result, there were problems in that only a point type of massage could be carried out and it was impossible to provide a massage which covered the entire surface of the areas of the body to be treated.

This type of portable massage device also had rolling members on the side of the cylindrical rotors which protruded to the outside. As a result, there was no massage effect from the rolling members themselves and no fat burning effect could be achieved.

Incidentally, women in particular have recently been looking for a way of eliminating fat from their upper arms and ankles as well as from their calves, thighs and other areas with adipose tissue. Thus, there has been a strong demand for development of a health and beauty massage device which can efficiently massage these areas and burn fat there.

The present invention was developed with the above-mentioned situation in mind. It is an object of the present invention to provide a health and beauty massage device which is configured so that the upper arms and ankles as well as the calves and thighs and other areas of the human body with adipose tissue can be massaged efficiently using multiple treatment members, which promotes circulation of the blood in each of these areas and which burns fat and which contributes to shaping a slim body for the user.

It is another object of the present invention to provide a health and beauty massage device in which the multiple treatment members efficiently make contact with the areas of the human body to be treated and which can enlarge the area which makes contact with these areas.

It is yet another object of the present invention to provide a health and beauty massage device in which the multiple treatment members make contact efficiently with the areas to be treated, even for those areas which have different diameters, since the device is adjustable to allow treatment of different-sized areas.

It is still another object of the present invention to provide a health and beauty massage device which rotates the multiple treatment members at the same speed in the same direction and which can make uniform rubbing contact on the areas to be treated in the same direction.

It is another object of the present invention to provide a health and beauty massage device which is configured so that the multiple treatment members which are disposed on the left and right of the areas to be treated rotate in opposite directions to provide a rubbing type of contact so that the areas to be treated are pushed toward each other from both sides to the center or are pulled apart from the middle to both sides.

The health and beauty massage device in the present invention has achieved each of the objectives mentioned above and is configured as follows.

The present invention is configured so that multiple treatment members are installed on a frame body which is provided with a recessed part into which the areas of the body to be treated are inserted or placed. At the same time, a linking means which is linked to each of the treatment members is disposed between the installation shafts of the adjoining treatment members. The treatment members are interlocked to at least one drive mechanism so that all of the treatment members can rotate.

Further, the present invention is configured so that the aforementioned treatment members are provided with large diameter rollers which protrude from the frame body to the inside of the recessed part so that the contact resistance relative to the areas of the body to be treated can be increased.

In addition, the aforementioned frame body is split into two or more parts and all of these split frame bodies are pivotable and form an integral piece so that the diameter of the recessed part of the frame body can be changed.

A linking means or a linking mechanism is also provided and is embodied by (1) shaft gears which are respectively attached to the ends of the installation shafts which support the treatment members; and (2) interposing gears which are disposed so that they interlock between these shaft gears.

Further, a linking means or linking mechanism is provided and is configured of (1) pulleys which are attached to the end of the installation shaft of each of the treatment members; and (2) an endless belt which is interposed between the adjoining pulleys.

As a result, the health and beauty massage device according to the present invention is configured as indicated previously and operates as follows.

In other words, the present invention disposes multiple treatment members along the recessed part of a frame body into which the areas of the human body to be treated are inserted or placed. Each of the treatment members can rotate, and all of the treatment members can rotate simultaneously via a linking means using a drive mechanism. As a result, the multiple treatment members make contact so that the areas of the human body to be treated which are inserted or placed inside the recessed part are covered and a rubbing rotation is carried out, thus promoting circulation of the blood all throughout the areas of the body to be treated and burning fat.

In the present invention, the aforementioned treatment members are provided with spiral-shaped and sinuate or wave-shaped rollers and other types of rollers with large diameters. As a result, the contact resistance relative to the areas of the body to be treated can be increased thus making it possible to burn fat in a highly efficient manner.

The aforementioned frame body is split into two or more pieces so that all of these split frame bodies are pivotable and an integral piece is formed, thus making it possible for the diameter of the recessed part of the frame body to be changed. As a result, the diameter of the device device can be adjusted to correspond to the arms and thighs and other areas of the body with different diameters which makes for a highly efficient treatment effect and a highly efficient fat burning effect.

The aforementioned linking means involves interposing and interlocking gears located between each of the shaft gears which are attached to the end of the installation shaft on each of the treatment members. As a result, when a single drive mechanism is placed on one end of the device, all of the treatment members can be rotated in the same direction. In addition, a single drive mechanism can be disposed in the middle of the recessed part on the frame body so that this interlocks with the shaft gears on both sides and additional drive mechanisms can be disposed on both ends of the recessed part on the frame body, the treatment members can be rotated in the same or opposite directions on both sides of the middle part.

The aforementioned linking means interposes an endless belt between the adjoining pulleys which are attached to the end of the installation shaft on each of the treatment members. As a result, when a single drive mechanism is disposed on one end and the pulleys on the treatment members are linked together by the endless belt, all of the treatment members can be rotated in the same direction. When drive mechanisms are disposed on both ends of the recessed part of the frame body, the treatment members can be rotated in opposite directions on both sides.

### BRIEF DESCRIPTION OF THE DRAWINGS

FIG. 1 is a perspective view of a practical embodiment of the health and beauty massage device of the present invention.

FIG. 2 is a perspective view of the FIG. 1 embodiment with the opposed halves of the massage device pivoted toward one another.

FIG. 3 is an end view of the FIG. 1 embodiment.

FIG. 4 is an end view similar to FIG. 3 which illustrates the linking mechanism.

FIG. 5 is an end view similar to FIG. 4.

FIG. 6 is an end view of a further embodiment of the massage device according to the present invention.

FIG. 7 is an end view similar to FIG. 6.

FIG. 8 is a perspective view of a further embodiment having oval-shaped treatment members.

FIG. 9 is a perspective view of a further embodiment having a variety of types of treatment members.

FIG. 10 is a perspective view of a further embodiment having a variety of types of treatment members.

FIG. 11 is a perspective view of a further embodiment having wave-shaped treatment members.

FIG. 12 is a perspective view of the massage device with a cover.

FIG. 13 is an explanatory view of the massage device according to the present invention being used on a leg.

FIG. 14 is an explanatory view of the massage device being used on an arm.

FIG. 15 is an end view of another embodiment of the massage device with an alternative linking mechanism.

FIG. 16 is a side view of the FIG. 15 embodiment.

FIG. 17 is a fragmentary side view similar to FIG. 16 but illustrating details of the linking mechanism.

FIG. 18 is a perspective view of another embodiment of the massage device.

FIG. 19 is an end view of the FIG. 18 embodiment.

### DETAILED DESCRIPTION

Next, we shall describe the health and beauty massage device of the present invention in greater detail based on practical embodiments of the invention which are indicated in the figures.

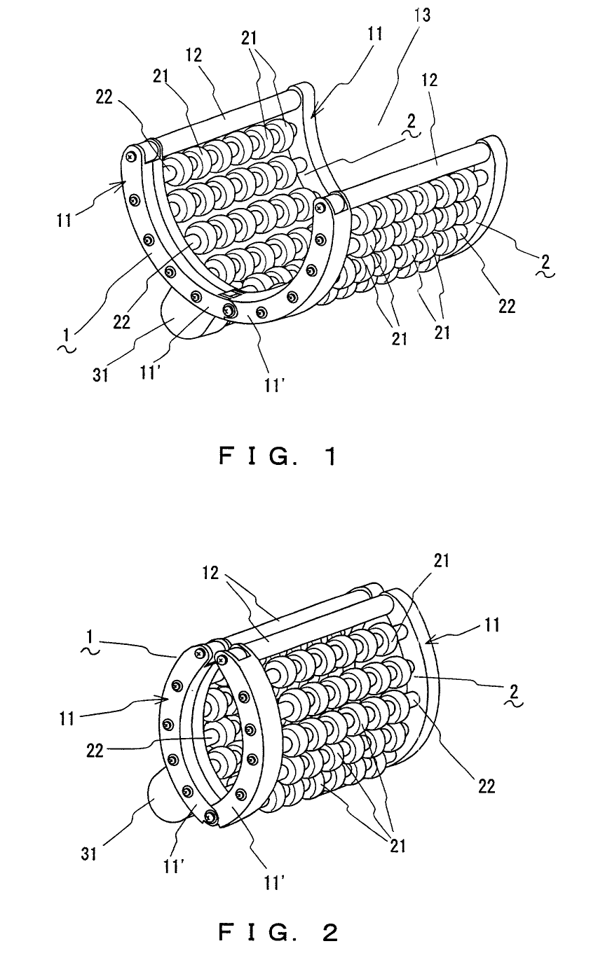

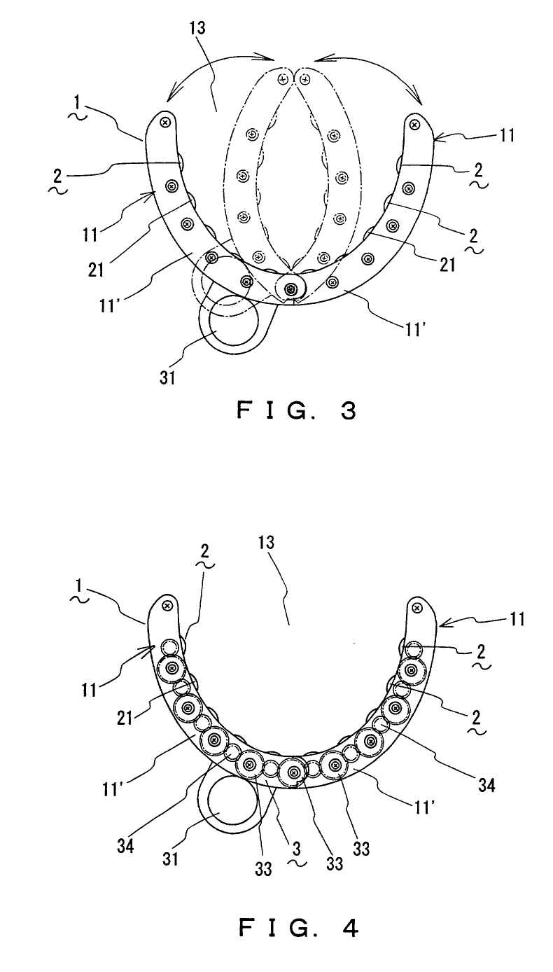

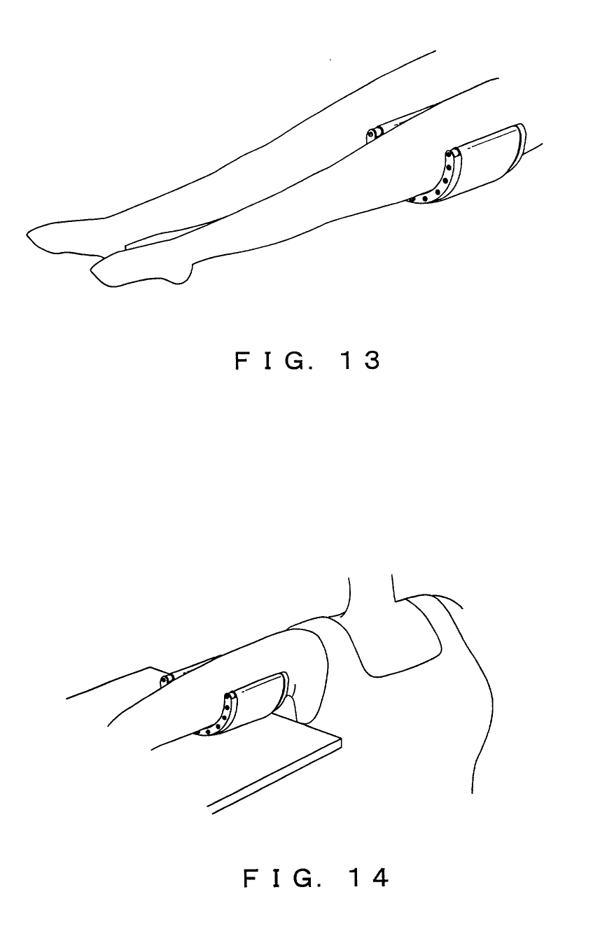

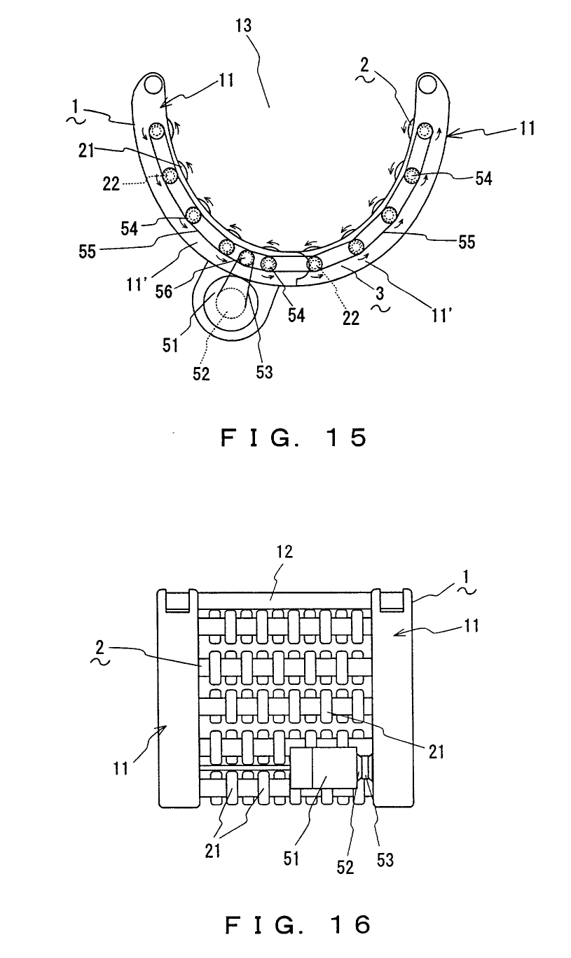

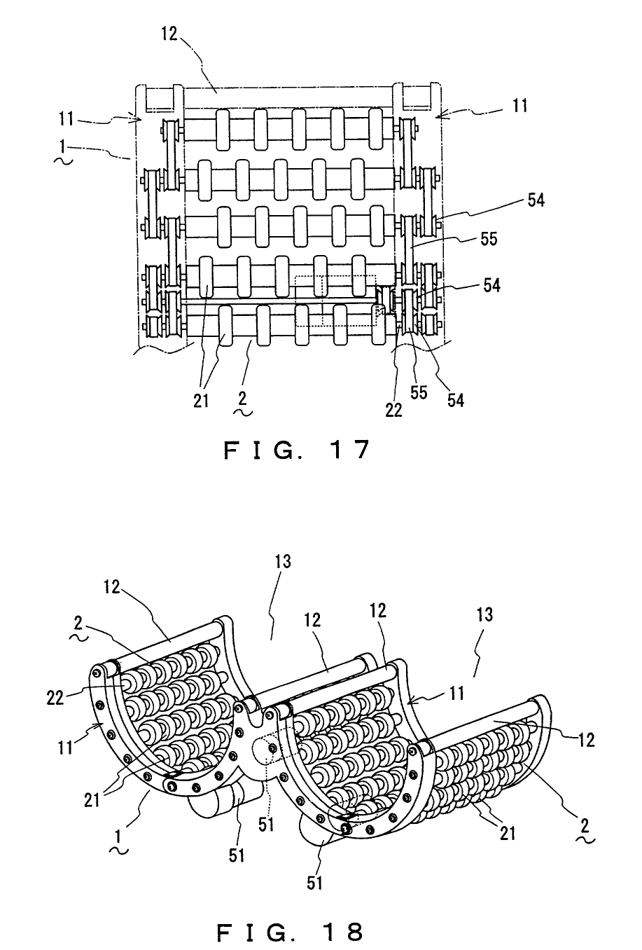

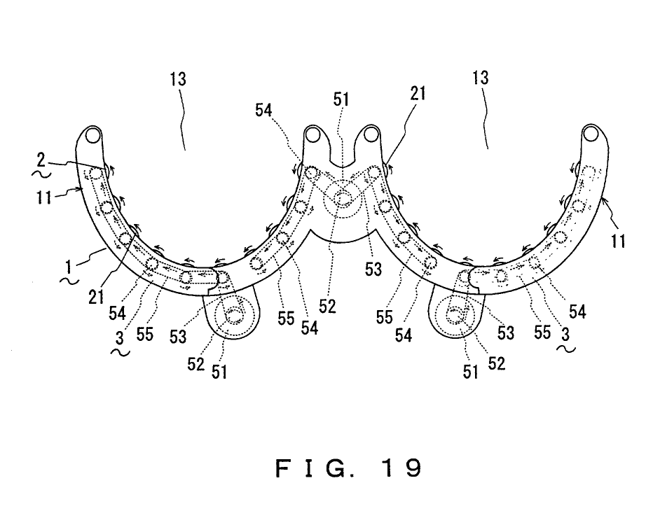

FIG. 1 and FIG. 2 are inclined views of a practical embodiment of the health and beauty device of the present invention. FIG. 3 through FIG. 7 are explanatory views of a practical embodiment of the health and beauty massage device of the present invention. FIG. 8 through FIG. 11 are inclined views of each of the practical embodiments of the health and beauty massage device of the present invention when various types of treatment members are set in place. FIG. 12 is an inclined view of a practical embodiment of the health and beauty massage device of the present invention when the cover is set in place. FIG. 13 and FIG. 14 are explanatory views of the health and beauty massage device of the present invention when it is being used. FIG. 15 through FIG. 17 are explanatory views of another practical embodiment of the health and beauty massage device of the present invention when the linking member is being used. FIG. 18 and FIG. 19 are explanatory views of another practical embodiment of the health and beauty massage device of the present invention.

The health and beauty massage device according to the present invention has multiple treatment members disposed on the frame body 1 which is provided with a recessed part 13 in which the areas of the human body to be treated are inserted or placed, as indicated in the practical embodiments shown in the figures. At the same time, a linking mechanism 3 (linking means) which is linked to each of the treatment members 2 is disposed between the installation shafts 22 of the adjoining or adjacent treatment members 2. The treatment members 2 interlock with one or more drive mechanisms 31 so that all of the treatment members 2 rotate.

The aforementioned frame body 1 has a recessed part 13 and includes (1) a pair of curved or arcuate members 11 and 11; and (2) retaining members 12 and 12 which are installed and extend transversely between the members 11 so that a constant interval is maintained between the curved members 11 and 11. Multiple treatment members 2 are installed along the recessed part 13 between this pair of curved members 11 and 11 so that they can rotate. All of the treatment members 2 make contact with the areas of the body to be treated which have been placed inside recessed part 13.

As indicated in FIG. 1 through FIG. 12, the aforementioned frame body 1 is characterized as follows. The center of the pair of curved members 11 and 11 which face each other is split in two such that each member or frame half 11 includes two generally parallel curved members 11′, 11′. The two pairs of split curved members 11′, 11′ and 11′, 11′ are pivoted near the center part and form an integral piece so that the diameter of the recessed part 13 on the frame body 1 can be changed In other words, the inner ends of the members 11′, 11′ of each half or member 11 are pivotably connected to one another so that the two opposed sides or halves of the frame body 1 can be moved toward and away from one another. This makes it possible to reduce the diameter of the recessed part 13 when an arm is being treated. When the thighs or other areas of the body are being treated, the diameter of the recessed part 13 can be increased, thus making the device adaptable for different areas of the body.

As indicated previously, at least one of the aforementioned treatment members 2 is installed along the recessed part 13 between the pair of curved members 11 and 11. The aforementioned treatment member 2 is configured of multiple contact members 21 which are supported on the aforementioned installation shaft 22 so that they form an integral piece and so that they can rotate. The aforementioned contact member 21 is shaped so that its diameter is larger than the width of the curved member 11 on the aforementioned frame body 1 so that member 21 protrudes at least inside the recessed part 13 and readily makes contact with the areas of the body to be treated.

These contact members 21 may be shaped in any way which is appropriate depending on the objective. They may be disc-shaped rollers as indicated in FIG. 1 and FIG. 2, oval rollers as indicated in FIG. 8 or sinuate or wave-shaped rollers as indicated in FIG. 11. They may also be spheroid rollers or spiral rollers (not shown).

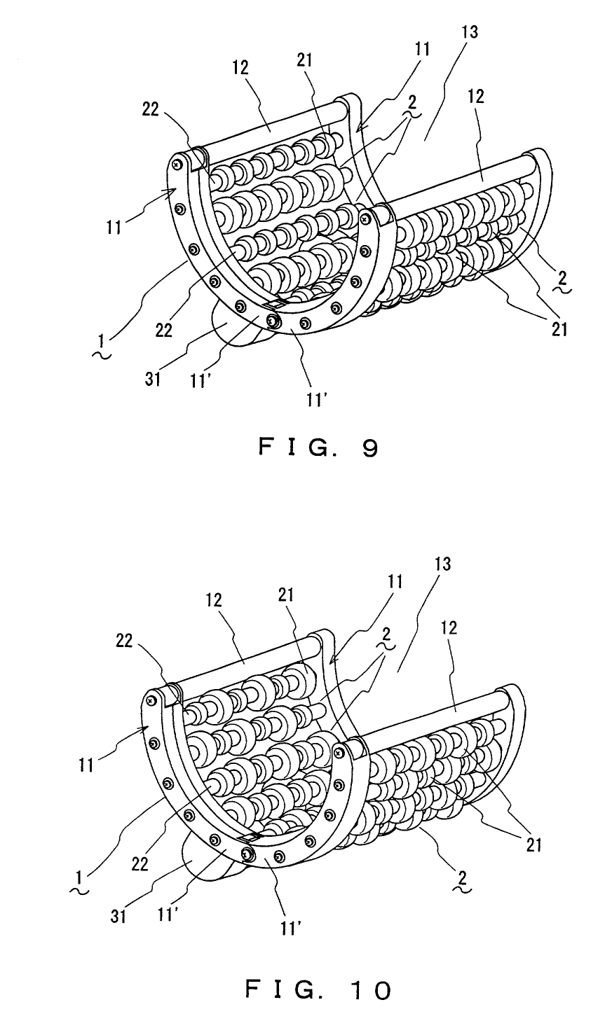

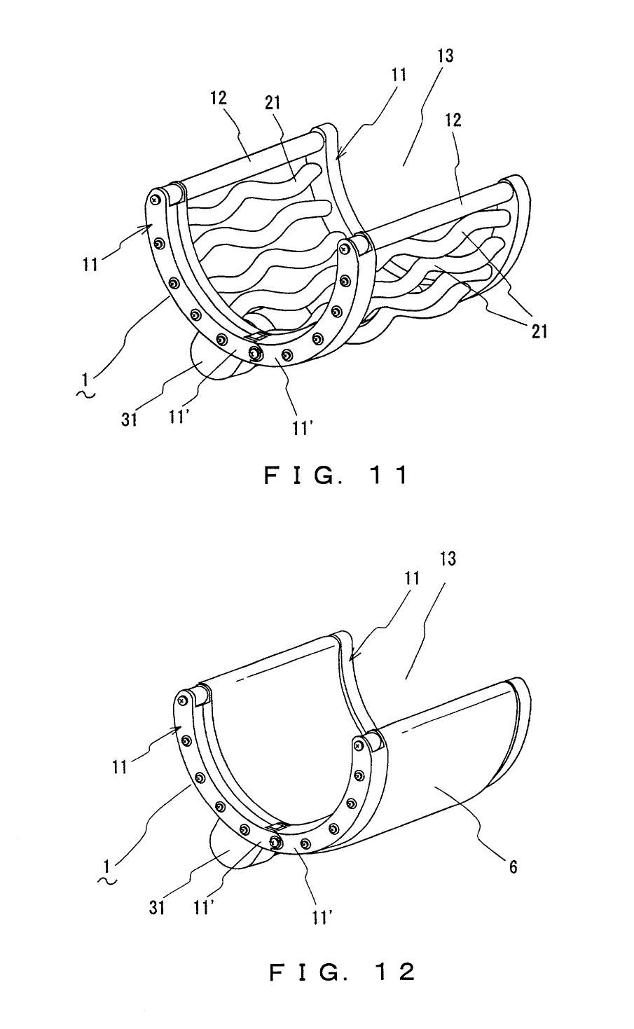

In addition, the contact members 21 which are supported on the aforementioned installation shaft 22 need not have the same shape as one another and may have a wide variety of different shapes as shown in FIGS. 9 and 10. The treatment members 2 may support different contact members 21 in any way depending on the user's choice. Further, numeral 6 indicated in FIG. 12 is a retractable cover which is used to cover all of the treatment members 2 installed on the aforementioned frame body 11. This cover 6 makes it possible to protect the skin on the areas of the body being treated from being irritated by direct contact with the treatment members 22.

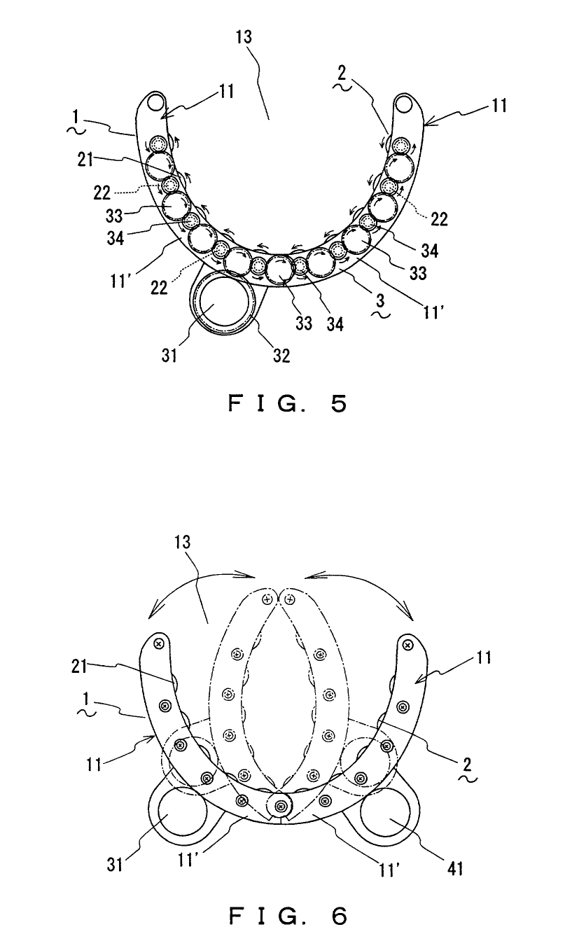

As indicated previously, the purpose of the aforementioned linking mechanism 3 (linking means) is to interlock the treatment members 2 with at least one drive mechanism 31 so that all of the treatment members 2 rotate at the same time. In the practical embodiments indicated in FIG. 4 and FIG. 5, an illustration is given of the aforementioned linking mechanism 3 which is configured of (1) shaft gears 34, each of which is attached to the end of an installation shaft 22 supporting the treatment members 2 and; (2) interposing gears 33 each of which is interposed between and interlocks with a pair of adjacent shaft gears 34, 34.

The aforementioned linking mechanism 3 and each of the treatment members 2 can be engaged or interlocked with one another by interlocking at least one shaft gear 34 or one interposing gear 33 with the drive gear 32 which is attached to the drive shaft of the aforementioned drive mechanism 31. The practical embodiment indicated in FIG. 5 illustrates how the interposing gear 33 interlocks with the drive gear 32 to rotate all of the treatment members 2 in the same direction.

Further, this interposing gear 33 need not necessarily be provided and the adjacent pairs of treatment members 2 can be rotated in opposite directions relative to one another by interlocking the aforementioned drive gear 32 directly with one shaft gear 34 which is attached to the end of the installation shaft 22.

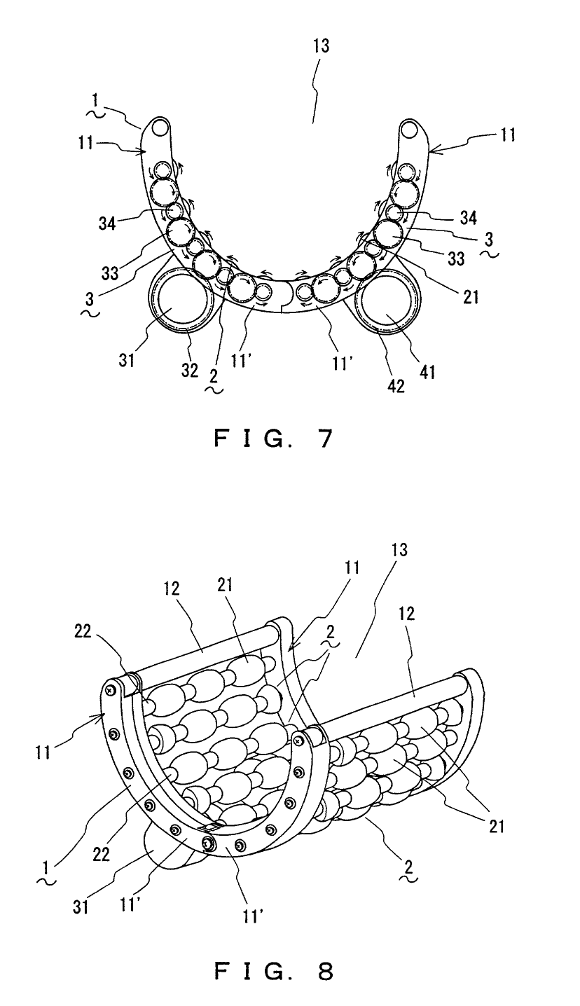

The practical embodiments indicated in FIG. 6 and FIG. 7 provide an example of two drive mechanisms 31 and 41 which have been set in place. The linking mechanism 3 in this case (linking means) interlocks the respective treatment members 2 with the two drive mechanisms 31 and 41 placed on the left and right so that all of the treatment members 2 rotate at the same time. In the aforementioned linking mechanism 3, groups which are a combination of (1) shaft gears 34 which are attached to the ends of the installation shafts 22; and (2) the interposing gears 33 which are interposed so that they interlock between two adjacent shaft gears 34 and 34 are separated into a left group and a right group.

As a result, the aforementioned linking mechanism 3 and all of the treatment members 2 of one group are engaged or interlocked by interlocking one shaft gear 34 or interposing gear 33 with each of the drive gears 32 and 42 which are attached to the drive shaft of the left and right drive mechanisms 31 and 41 mentioned previously (the figure illustrates interlocking with the interposing gear 33) so that the left and right treatment member groups which are on either side of the middle of the recessed part 13 can be rotated in opposite directions from one another on opposite sides of the middle part.

Further, the direction in which the treatment members 2 rotate can be determined depending on whether or not there are interposing gears 33, mentioned previously. If the shaft gear 34 and the interposing gear 33 are disposed so as to interlock with one another, the treatment members 2 of a treatment member group can rotate in the same direction. If the shaft gears 34 are disposed in a series with one another, the treatment members 2 of a treatment member group can be rotated in directions which are opposite to one another. As a result, any combination of these shaft gears 34 and interposing gears 33 may be set depending on the objective.

FIGS. 15 through 19 illustrate the aforementioned linking mechanism 3 when it is configured of (1) one or more pulleys 54 which are attached to the ends of the respective installation shafts 22; and (2) an endless belt 55 which is interposed between each adjacent pair of pulleys 54 and 54.

This means that (1) the linking mechanism 3 and (2) all of the treatment members 2 which use this linking mechanism 3 are interlocked by providing a configuration which links (1) a drive pulley 52 which is attached to the drive shaft of one or more drive mechanisms 51 as mentioned previously; and (2) a pulley 56 which is attached to the end of the drive shaft of the aforementioned drive mechanism 51 using an endless belt 53 used for starting, so that all of the treatment members 2 can interlock and rotate in the same direction simultaneously. However, the adjoining treatment members 2 and 2 can also interlock and rotate simultaneously in opposite directions.

FIG. 17 indicates all of the treatment members 2 when they are configured so that they are interlocked and rotate in the same direction. By (a) fixing two pulleys 54 with the same diameter to both ends of each installation shaft 22; (b) successively interposing endless belts 55 used for starting between adjacent pulleys 54 and 54; and (c) interposing an endless belt 53 used for starting on the drive pulley 52 on the drive mechanism 51 and on the pulley 54 which is fixed to one of the aforementioned installation shafts 22; or on interposing pulley 56 (see FIG. 15) which is interposed beforehand between both of the aforementioned pulleys 54 and 54, all of the treatment members 2 can interlock with the drive mechanism 51 and rotate in the same direction.

The practical embodiments indicated in FIGS. 18 and 19 illustrate two of the aforementioned frame bodies 1 when they are linked in side by side relation with one another and so that all of the treatment members 2 are rotatable. These practical embodiments illustrate disposition of three drive mechanisms 51. As indicated in FIG. 19, the linking mechanism 3 (linking means) in this case involves interposing successively endless belts 55 between the adjacent pulleys 54 and 54, interposing endless belts 53 used for starting on (a) the drive pulleys 52 and 52 on the two drive mechanisms 51 and 51 on the left and right and on (b) the pulley 54 which is attached to one of the aforementioned installation shafts 22 on the left and right and disposing a drive mechanism 51 in the middle of both frame bodies 1 and 1 to further ensure the stability of the torque. At the same time, by interposing endless belts 53 used for starting on (a) the drive pulley 52 on the aforementioned middle drive mechanism 51 and on (b) pulleys 54 and 54 on the treatment members 2 and 2 which are respectively disposed at the upper extent of the aforementioned frame bodies 1 and 1, all of the drive mechanisms 51 are rotated in the same direction and all of the treatment members 2 can be rotated simultaneously in the same direction.

Further, when two drive mechanisms 51 and 51 are disposed on the left and right as indicated previously, a drive mechanism 51 need not be provided in the middle of both frame bodies 1 and 1. By selecting and setting the rotating direction for the drive mechanisms 51 and 51, all of the treatment members 2 which are disposed on the frame bodies 1 and 1 on the left and right can be rotated in the same direction. At the same time, the treatment members 2 on the frame bodies 1 and 1 on the left and right can be rotated in opposite directions.

Even when the drive mechanism 51 which is disposed in the middle of both of the aforementioned frame bodies 1 and 1, two drive mechanisms 51 and 51 need not be provided on the left and right. By selecting and setting the rotating direction of the drive mechanism 51 in the middle, all of the treatment members 2 which are disposed on the frame bodies 1 and 1 on the left and right can be rotated in the same direction.

In addition, the linking mechanisms 3 which are indicated in each of the practical embodiments above are examples of using (1) shaft gears 34 and interposing gears 33; and of using (2) pulleys 54 and endless belts 55. However, both of these may be used at any time and any means may be used as long as the treatment members 2 are linked and rotated.

As a result, when using the health and beauty massage device which has the aforementioned configuration, all the user has to do is place the areas on her calves and thighs to be treated as well as the areas on her upper arms and ankles inside the recessed part 13 of the frame body 11, as indicated in FIG. 13 and FIG. 14, and operate any of the drive mechanisms 31, 41 and 51. All of the treatment members 2 make contact with the areas of the body to be treated which are inside the recessed part 13 and an efficient massage can be carried out by the rubbing and rotating action of the device, and the circulation of the blood in all of the areas to be treated can be promoted and fat can be burned.

Further, the aforementioned drive mechanisms 31, 41 and 51 can be rotated in a selected direction. Since multiple mechanisms are used, any of the drive mechanisms 31, 41 and 51 can be used and the direction of rotation can be changed and selected. This makes it possible to provide a massage using a rubbing type of rotation in a clamped mode as well as a rubbing type of rotation in a rubbing mode using each of the treatment members 2 on any of the treatment areas so that the device can be adapted to the areas of the body being treated. Further, it is also within the scope of the invention to provide a microcontroller and reversible electric motors as the drive mechanisms 31, 41 and 51, whereby the microcontroller controls the drive mechanisms and reversely rotates same so that the treatment members can reciprocate or move back-and-forth.

As indicated above, the health and beauty massage device of the present invention is configured by installing multiple treatment members along the recessed part of a frame body into which the areas of the body to be treated can be placed or inserted, so that the treatment members can rotate and by rotating each of the treatment members via a linking means using a drive mechanism. As a result, a large number of rolling members which can rotate freely outside the rotors can be provided. Unlike prior-art massage devices which used only point contact with a rolling member, multiple treatment members make contact, rub and rotate so that the areas of the body which are placed inside the recessed part can be covered, the circulation of the blood in the areas of the body to be treated can be promoted and fat can be burned.

The present invention uses the aforementioned treatment members which have spheroid rollers and oval rollers with large diameters which protrude from the frame body into the recessed part as well as spiral rollers and sinuate or wave-shaped rollers and other types of rollers with large diameters. As a result, the contact resistance relative to the areas of the body to be treated can be increased, unlike the prior-art portable massage devices, thus making it possible to burn fat in a highly efficient manner.

In the present invention, the aforementioned frame body is split into two or more parts, each of these split frame bodies is pivoted thus forming an integral piece and making it possible to change the diameter of the recessed part of the frame body. As a result, unlike the prior-art portable massage devices, it is adapted to the diameter of the recessed part of the frame body which is made to correspond to the arms and thighs and other areas of the body to be treated which have different diameters, covering all of the areas of the body to be treated, thus making it possible to provide a highly efficient treatment effect and a highly efficient fat burning effect.

In the present invention, the aforementioned linking means involves interlocking and interposing the interposing gears between each of the shaft gears which are attached to the end of the installation shaft on each of the treatment members. As a result, unlike prior-art portable massage devices in which all of the rolling members rotated only in the same direction, the direction of rotation of each of the adjoining treatment members in this device can be set as is appropriate. When a single drive mechanism is disposed on one end, all of the treatment members can be rotated in the same direction. In addition, when a single drive mechanism is disposed in the middle of the recessed part of the frame body so that this is interlocked on the shaft gears on both sides and when additional drive mechanisms are disposed on both ends of the recessed part of the frame body, the treatment members can be rotated in the same or opposite directions on both sides of the middle part.

In the present invention, the aforementioned linking means involves interposing an endless belt between the adjoining pulleys which are fixed to the end of the installation shaft of each of the treatment members. As a result, unlike the prior-art portable massage devices in which all of the rolling members rotated only in the same direction, even using this linking means, the direction of rotation of each of the adjoining treatment members in the device in the present invention can be set as is appropriate. When a single drive mechanism is disposed on one end and the pulley of the treatment members is linked using an endless belt, all of the treatment members can be rotated in the same direction. Moreover, when drive mechanisms are disposed on both ends of the recessed part of the frame body, the treatment members can be rotated in opposite directions on both sides of the middle part.

As a result, the health and beauty massage device in the present invention is configured so that the multiple treatment members make contact so that the areas of the body to be treated are covered and a rubbing type of rotation takes place. As a result, a large number of rolling members which can rotate freely around the outside of the rotors can be provided. Unlike the prior-art portable massage devices which used only point contact with the rolling members, the present invention makes it possible to efficiently promote the circulation of the blood over the entire area to be treated and to burn fat efficiently so that it is effective in slimming the shape of the body.

What is claimed is:

1. A health and beauty massage device comprising multiple treatment members disposed on a frame which is provided with a recessed part into which the areas of the body to be treated are placed, and linking means which links each of the treatment members between installation shafts thereof and interlocks the treatment members to at least one drive mechanism so that each of the treatment members rotates.

2. The device of claim 1 wherein the treatment members are provided with large diameter rollers which protrude from the frame body into the recessed part so that the contact resistance relative to the areas of the body to be treated can be enlarged.

3. The device of claim 1 wherein the frame body is split into two or more frame bodies and each of these split frame bodies is pivoted thus forming an integral piece so that the diameter of the recess part on the frame body can be changed.

4. The device of claim 1 wherein the linking means is configured of (1) shaft gears which are attached to the end of the installation shafts of each of the treatment members; and (2) interposing gears which are interposed so that they interlock between each of these shaft gears.

5. The device of claim 1 wherein the linking means is configured of (1) a pulley which is attached to the end of the installation shafts of each of the treatment members; and (2) an endless belt which is interposed between the adjacent pulleys.
